(19) United States
(12) Patent Application Publication
(10) Pub. No.: US 2023/0211832 A1
(43) Pub. Date: Jul. 6, 2023

(54) HIGH STRENGTH/HIGH ELONGATION ALLOY HAVING HIGH IRON CONTENT AND VEHICLE PART HAVING THE SAME

(71) Applicants: HYUNDAI MOTOR COMPANY, Seoul (KR); KIA CORPORATION, Seoul (KR)

(72) Inventor: Hee-Sam Kang, Seoul (KR)

(21) Appl. No.: 17/811,951

(22) Filed: Jul. 12, 2022

(30) Foreign Application Priority Data
Jan. 3, 2022 (KR) 10-2022-0000195

(51) Int. Cl. B62D 29/00; C22C 21/04

(52) U.S. Cl. CPC B62D 29/008; C22C 21/04; B62D 21/155

(57) ABSTRACT

Disclosed are a subframe for a vehicle part having the high strength and high elongation by including the high iron content and an aluminum alloy composition with increased content of iron (Fe). The aluminum alloy composition includes an amount of about 0.15 to 0.25 wt % of iron (Fe), an amount of about 0.2 to 0.25 wt % of manganese (Mn), an amount of about 0.15 to 0.25 wt % of magnesium (Mg), an amount of about 7.5 to 9.0 wt % of silicon (Si), and an amount of about 0.5 wt % or less of inevitable impurities, and a balance of aluminum (Al), and all the wt % are based on the total weight of the aluminum alloy composition.

### CROSS-REFERENCE TO RELATED APPLICATION

This application claims priority to Korean Patent Application No. 10-2022-0000195, filed on Jan. 3, 2022, which is incorporated herein by reference in its entirety.

### TECHNICAL FIELD

The present invention relates to an aluminum alloy having high strength and high elongation, and in particular, to a vehicle part including a subframe including aluminum alloy having a high iron content capable of maintaining high strength and high elongation properties while reducing the amount of high purity alloy element used.

### BACKGROUND

In general, a subframe of a vehicle, for example, a shock absorber housing as a chassis part, includes a high strength/high elongation alloy to have the physical properties capable of absorbing shock and minimizing mechanical damage to ensure customer safety upon collision. In particular, the high strength/high elongation alloy is required to have excellent castability in addition to strength and elongation when applied to these parts because the applied parts are large in size and thin.

In the related art, for example, an Al—Si-based or Al—Mg-based high strength/high elongation alloy has been reported. In particular, the Al—Si-based or Al—Mg-based high strength/high elongation alloy generates an α-AlFeSiMn phase other than an acicular phase by adding manganese (Mn) due to an iron component, which causes reducing elongation by reacting with silicon (Si) but is the main alloy element, to form an acicular β-AlFeSi.

The high strength/high elongation alloy has been manufactured by strictly limiting the content of iron (Fe) as an impurity component in the alloy, to secure a high elongation of 10% or greater regardless of the portion of the applied part as well as the satisfaction of the strength and elongation required for the parts of the shock absorber housing. However, in the high strength/high elongation alloy, when the amount of manganese (Mn) increases, the elongation decreases, and therefore, there is a difficulty in which the content of the iron (Fe) should be maintained to be low. For example, the manufacturing cost of the alloy is high because the high strength/high elongation alloy should be used for the high purity alloy element.

### SUMMARY

In preferred aspects, provided is an aluminum alloy having high strength and high elongation by including the high iron content. The alloy may be an Ni-free high strength/high thermal conductivity Al—Mn—Fe alloy that can provide elongation of the level of the mass-produced alloy by making the content of the manganese greater than or at least equal to the content of the iron while increasing the content of the iron (Fe). In particular, the alloy of the present invention may be Al—Si-based or Al—Mg-based and have high strength/high elongation properties by reducing the content of the iron (Fe) and reducing the use of the high purity alloy element.

In an aspect, provided is an aluminum alloy including an alloy composition, which includes iron (Fe), manganese (Mn), magnesium (Mg), silicon (Si), and other inevitable impurities, and balance of aluminum (Al). Preferably, the aluminum alloy is made of an alloy composition, and the alloy composition includes: an amount of about 0.15 wt % to 0.25 wt % of iron (Fe), an amount of about 0.2 to 0.25 wt % of manganese (Mn), an amount of about 0.15 to 0.25 wt % of magnesium (Mg), an amount of about 7.5 to 9.0 wt % of silicon (Si), an amount of about 0.5 wt % or less of inevitably impurities, and a balance of aluminum (Al), all the wt % are based on the total weight of the alloy composition. The content of manganese (Mn) in the alloy composition is equal to or greater than the content of iron (Fe) in the alloy composition.

The alloy composition may consist of, essentially consist of, or consist essentially of: an amount of about 0.15 wt % to 0.25 wt % of iron (Fe), an amount of about 0.2 to 0.25 wt % of manganese (Mn), an amount of about 0.15 to 0.25 wt % of magnesium (Mg), an amount of about 7.5 to 9.0 wt % of silicon (Si), an amount of about 0.5 wt % or less of inevitably impurities, and a balance of aluminum (Al), all the wt % are based on the total weight of the alloy composition. The content of manganese (Mn) in the alloy composition is equal to or greater than the content of iron (Fe) in the alloy composition.

The content of iron (Fe) in the alloy composition may be of about 0.15 to 0.25 wt % based on the total weight of the alloy composition and the content of manganese may be greater than or equal to the content of iron. The iron (Fe) may cause die-soldering of the alloy composition when the content thereof is less than about 0.15 wt %, and may cause the coarsening of the intermetallic compound of the alloy composition when the content thereof is greater than about 0.25 wt %.

The content of manganese (Mn) may be an amount of about 0.2 to 0.25 wt %. The manganese (Mn) may cause die-soldering of the alloy composition when the content thereof is less than about 0.2 wt %, and may cause the coarsening of the intermetallic compound of the alloy composition when the content thereof is greater than about 0.25 wt %.

The content of the magnesium (Mg) may be an amount of about 0.15 to 0.25 wt %, the magnesium (Mg) may generate a MgSi phase of the alloy composition when the content thereof is about 0.15 wt % or greater, and may generate a coarse AlFeSiMnMg phase of the alloy composition when the content thereof is greater than about 0.25 wt %.

The content of the silicon (Si) may be an amount of about 7.5 to 9.0 wt %, the silicon (Si) may cause the reduction in fluidity of the alloy composition when the content thereof is less than about 7.5 wt %, and may generate a β-AlFeSi phase while increasing a Si phase of the alloy composition when the content thereof is greater than about 9.0 wt %.

The contents of other inevitable impurities may be about 0.5 wt % or less.

In an aspect, provided is a vehicle part including a subframe. The subframe includes an alloy composition including an amount of about 0.15 to 0.25 wt % of iron (Fe), an amount of about 0.2 to 0.25 wt % of manganese (Mn), an amount of about 0.15 to 0.25 wt % of magnesium (Mg), an amount of about 7.5 to 9.0 wt % of silicon (Si), and an amount of about 0.5 wt % or less of inevitable impurities, and a balance of aluminum (Al), wt % based on the total weight of the alloy composition.

The subframe may be manufactured by dissolving the alloy composition, injecting molten metal into a mold to mold a product, and processing the cast product extracted from the mold.

The aluminum alloy having the high iron content for the vehicle part according to exemplary embodiments of the present invention implements the following operations and effects.

Also provided is a vehicle that includes the aluminum alloy including the alloy composition as described herein.

Further provided is a vehicle that includes the subframe including the alloy composition as described herein.

First, it is possible to implement the advantage capable of maintaining the high strength/high elongation properties by reducing the amount of the high purity alloy element used. Second, it is possible to save the cost by reducing the amount of the high purity alloy element used with the Ni-free high strength/high thermal conductivity Al—Mn—Fe alloy having the elongation of the level of the mass-produced alloy even while having the high iron content compared to the conventional one. Third, it is possible to manufacture the shock absorber housing and the front/rear subframes with the high strength/high elongation alloy having the high iron content, thereby saving the costs of the ingot of the shock absorber housing and the ingots of the front/rear subframe and increasing the scrap use rate. Fourth, it is possible to establish the process of manufacturing the high strength/high elongation alloy capable of securing the technology based on the carbon-neutral response in the future. Fifth, it is possible to make the content of the manganese larger than or at least equal to the content of the iron at all times, thereby preventing the phenomenon that forms the acicular β-AlFeSi and reduces elongation if the content of the iron (Fe) is larger than the content of the manganese (Mn). Other aspects of the invention are disclosed infra.

### BRIEF DESCRIPTION OF THE DRAWINGS

FIG. 1 shows an exemplary vehicle part to which an exemplary aluminum alloy having a high iron content according to the present invention is applied is cast as a subframe.

FIG. 2 shows Evaluation Examples for a change in castability of the content of silicon according to an exemplary embodiment of the present invention.

### DETAILED DESCRIPTION

Hereinafter, an exemplary embodiment of the present invention will be described in detail with reference to the accompanying exemplary drawings, and since these exemplary embodiments are examples and can be implemented by those skilled in the art to which the present invention pertains in various different forms, they are not limited to the exemplary embodiment described herein.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

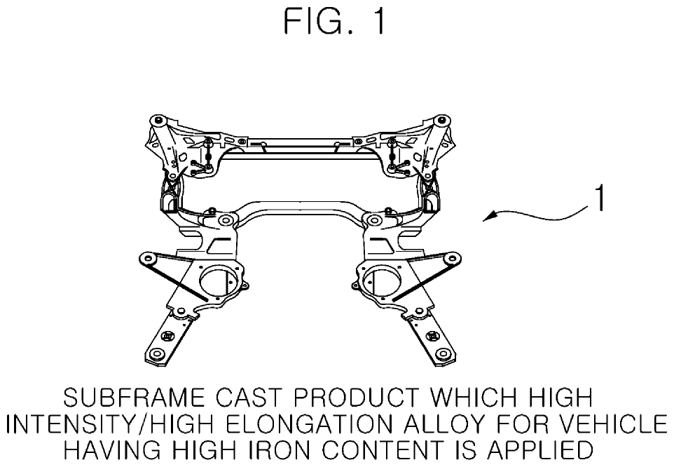

FIG. 1 shows an exemplary vehicle subframe 1 made of an aluminum alloy, in which the subframe 1 is manufactured by dissolving an alloy composition, injecting molten metal into a mold to mold the product, and processing a cast product extracted from the mold according to the order of dissolving the alloy->injecting the molten metal into the mold (molding the product)->processing. The alloy is an alloy that both non-heat treatment (as-cast)/heat treatment (T5, T6) can be specified, in which T5 refers to a heat treatment symbol that means a state of being artificially aged after rapid cooling from a high temperature processing, and T6 refers to a heat treatment symbol that means a state of being artificially aged after solubilization treatment.

In particular, the aluminum alloy includes an alloy composition containing aluminum (Al), iron (Fe), silicon (Si), magnesium (Mg), manganese (Mn) and other inevitable impurities. The aluminum alloy may suitably include an amount of about 0.15 to 0.25 wt % of iron (Fe), an amount of about 7.5 to 9.0 wt % of silicon (Si), an amount of about 0.15 to 0.25 wt % of magnesium (Mg), an amount of about 0.2 to 0.25 wt % of manganese (Mn), and other inevitable impurities of about 0.5 wt % or less; a balance of aluminum (Al), all the wt % are based on the total weight of the alloy composition.

Therefore, the subframe 1 may be formed of the aluminum alloy having high strength/high elongation, which maintains the relatively high content of iron (Fe). The iron may cause formation of an acicular β-AlFeSi by reacting with silicon (Si) that is the main alloy element of the high strength/high elongation alloy and reduces elongation.

Table 1 shows an alloy composition range (wt %) obtained by comparing Example of the present invention with Comparative Examples 1, 2.

TABLE 1

| | Composition range | | | | | |
|---|---|---|---|---|---|---|
| | | | | | | Re- |
| Items | Si | Mg | Fe | Mn | Ni | mark |
| Present | 7.5-9.0 | 0.15-0.25 | 0.15-0.25 | 0.2-0.25 | 0.05-0.15 | Fe ≤ |
| invention | | | | | | Mn |
| Compar- | 10 | 0.3 | 0.1 | 0.65 | — | — |
| ative Ex- | | | | | | |
| ample 1 | | | | | | |
| Compar- | 9 | — | 0.1 | 0.6 | — | — |
| ative Ex- | | | | | | |
| ample 2 | | | | | | |

Here, Comparative Example 1 represents a Silafont alloy of die-casting, and

Comparative Example 2 represents a Castasil alloy of casting.

As shown in Table 1, the subframe 1 is subjected to composition component management as follows for the elongation and strength of the alloy. In particular, the elongation of the alloy may be formed by adjusting the contents of iron (Fe), manganese (Mn), and magnesium (Mg).

For example, the minimum content of iron (Fe) for high elongation may be not less than about 0.15 wt %, and the minimum content of manganese (Mn) may not be less than about 0.2 wt %. When the minimum content of iron (Fe) is reduced to less than about 0.15 wt % in connection with the content of manganese (Mn), sand burning occurs in the mold during a casting process.

On the other hand, the maximum content of iron (Fe) for high elongation may not be greater than about 0.25 wt %, and the maximum content of manganese (Mn) may not be greater than about 0.25 wt %. When each of iron (Fe) and manganese (Mn) is greater than about 0.25 wt %, the high elongation characteristics may not be secured due to the coarsening of intermetallic compounds because the elongation decreases as the contents of both iron (Fe) and manganese (Mn) increase.

For example, the minimum content of magnesium (Mg) may be in an amount of about 0.15 wt % or greater and not greater than about 0.25 wt %. When the content of magnesium (Mg) is about 0.15 wt % or greater, the strength of the alloy may be secured by generating an Mg2Si phase having a reinforcing structure. When the content of magnesium (Mg) is greater than about 0.25 wt %, the high elongation characteristics may not be secured any more by generating the coarse AlFeSiMnMg phase.

When the content of iron (Fe) is greater than the content of manganese (Mn), the acicular β-AlFeSi may be formed to reduce elongation. The content of manganese may be greater than or at least equal to the content of iron.

Table 2 shows Test Example 1 for the contents of iron (Fe) and manganese (Mn).

TABLE 2
Changes in die-soldering characteristics and elongation according
to the contents of iron and manganese (Test Example 1)

| Items | Fe | Mn | die-soldering | Elongation |
|---|---|---|---|---|
| ※1 | 0.13 | 0.20 | X | ◯ |
| ※2 | 0.15 | 0.18 | X | ◯ |
| ※3 | 0.15 | 0.20 | ◯ | ◯ |
| ※4 | 0.19 | 0.20 | ◯ | ◯ |
| ※5 | 0.21 | 0.20 | ◯ | X |
| ※6 | 0.21 | 0.23 | ◯ | ◯ |
| ※7 | 0.25 | 0.25 | ◯ | ◯ |
| ※8 | 0.25 | 0.27 | ◯ | X |

As can be seen from the results of evaluating the changes in die-soldering characteristics and elongation according to the contents of iron (Fe) and manganese (Mn) in Table 2, casting may be possible without die-sand burning problem only when an amount of 0.15 wt % of iron (Fe) and an amount of 0.2 wt % or greater of manganese (Mn) are added. In addition, when the content of iron (Fe) is greater than the content of manganese (Mn) or the contents of iron (Fe) and manganese (Mn) is greater than 0.25 wt %, it is necessary to limit the contents thereof because it is not possible to obtain the target high elongation characteristics.

In other words, for iron (Fe) and manganese (Mn) for high elongation, the content of manganese (Mn) may be greater than or at least equal to the content of iron (Fe) so that the acicular β-AlFeSi that reduces elongation when the content of iron (Fe) is greater than the content of manganese (Mn) is not formed.

In particular, the strength of the alloy may be formed by adjusting the content of nickel (Ni).

For example, since nickel (Ni) may improve the strength while preventing the iron-based compound from becoming the acicular phase, the content thereof is added up to 0.05 to 0.15 wt % to supplement the strength, so that the high strength required by the alloy is formed.

Table 3 shows Test Example 2 for the content of nickel (Ni).

TABLE 3
Changes in strength and elongation according
to the content of nickel (Test Example 2)

| | | | | Yield | |
|---|---|---|---|---|---|
| Items | Fe | Mn | Ni | strength | Elongation |
| ※1 | 0.2 | 0.23 | 0.00 | 95 | ◯ |
| ※2 | 0.2 | 0.23 | 0.05 | 105 | ◯ |
| ※3 | 0.2 | 0.23 | 0.10 | 125 | ◯ |
| ※4 | 0.2 | 0.23 | 0.15 | 135 | ◯ |
| ※5 | 0.2 | 0.23 | 0.17 | 140 | X |

As can be seen from the results of evaluating the changes in strength and elongation according to the content of nickel (Ni) in Table 3, the strength improvement effect appears when the content of about 0.05 wt % or greater is added, and the strength increases as the content increases. However, since the alloy cannot secure the target high elongation characteristics any more when the content of nickel (Ni) is greater than about 0.15 wt %, it is necessary to limit the amount thereof.

The castability of the alloy is formed by adjusting the content of silicon (Si).

For example, the content of silicon (Si) may determine the castability of the alloy, and the minimum content of silicon (Si) may be about 7.5 wt % or greater, and the maximum content thereof may not be greater than 9.0 wt %. When the content of silicon (Si) is reduced to less than about 7.5 wt %, the fluidity may be reduced, thereby causing non-molding during casting. When the content of silicon (Si) is greater than 9.0 wt %, the β-AlFeSi phase may be generated with the increase in the process Si phase, and therefore, the alloy cannot secure the target high elongation characteristics any more. Therefore, it is necessary to limit the amount thereof.

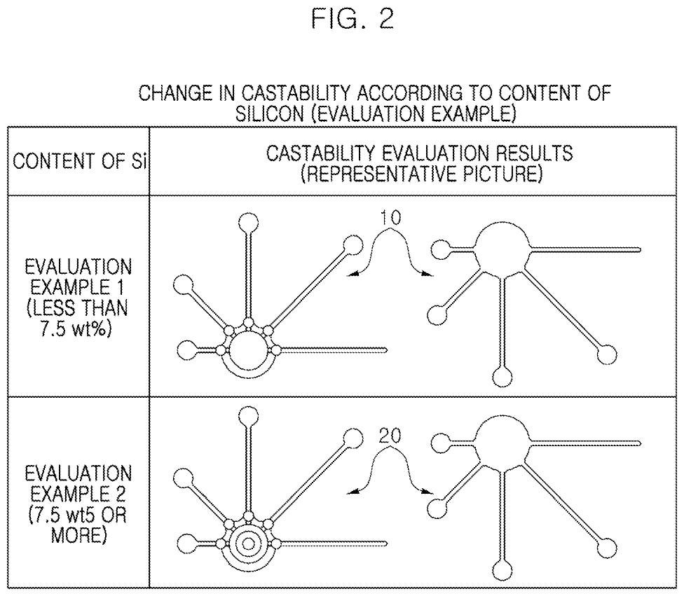

As shown in Evaluation Examples 1 and 2, which are the results of the change in castability according to the content of silicon (Si) in FIG. 2, Evaluation Example 1 represents a first prototype 10 for castability evaluation to which the content of silicon (Si) was applied at less than 7.5 wt %, and Evaluation Example 2 represents a second prototype 20 for castability evaluation to which the content of silicon (Si) was applied at 7.5 wt % or greater. For example, for the first prototype 10 for castability evaluation, a branch portion of the test piece was not filled due to reduced fluidity during casting with less than 7.5 wt % of the content of silicon (Si).

On the other hand, for the second prototype 20 for castability evaluation, the branch portion of the test piece was completely filled because there was no problem in fluidity during casting with 7.5 wt % or more of the content of silicon (Si). However, the content of silicon (Si) further improves fluidity whereas making it impossible to secure the target high elongation characteristics of the alloy. Therefore, it is necessary to limit the amount thereof not to greater than 9.0 wt %.

As described above, the subframe 1 for the vehicle part having the high strength/high elongation having the high iron content according to an exemplary embodiment of the present invention can be made of the Ni-free high strength/high thermal conductivity Al—Mn—Fe alloy, which can provide the elongation of the level of the mass-produced alloy. The alloy composition may include an amount of about 0.15 to 0.25 wt % of iron (Fe), an amount of about 0.2 to 0.25 wt % of manganese (Mn), an amount of about 0.15 to 0.25 wt % of magnesium (Mg), an amount of about 7.5 to 9.0 wt % of silicon (Si), an amount of about 0.5 wt % or less of other inevitable impurities, and a balance of aluminum (Al), as wt % based on the total weight of the alloy composition. In particular, the content of manganese may be greater than or at least equal to the content of iron even while increasing the content of iron (Fe), and the Al—Si-based or Al—Mg-based high strength/high elongation properties may be maintained by reducing the content of iron (Fe) and reducing the use of the high purity alloy element.

Therefore, the subframe 1 may be manufactured as the iron vehicle parts according to various exemplary embodiments of the present invention using the high strength/high thermal conductivity aluminum alloy composition as descried herein, which is characterized in that the content of manganese is always equal to or greater than the content of iron.

What is claimed is:

1. An aluminum alloy,
wherein the aluminum alloy is made of an alloy composition, the alloy composition comprising: an amount of about 0.15 wt % to 0.25 wt % of iron (Fe), an amount of about 0.2 to 0.25 wt % of manganese (Mn), an amount of about 0.15 to 0.25 wt % of magnesium (Mg), an amount of about 7.5 to 9.0 wt % of silicon (Si), an amount of about 0.5 wt % or less of inevitably impurities, and a balance of aluminum (Al), all the wt % are based on the total weight of the alloy composition, and
wherein the content of manganese (Mn) in the alloy composition is equal to or greater than the content of iron (Fe) in the alloy composition.

2. The aluminum alloy of claim 1, wherein the alloy composition further comprises nickel (Ni) to control a strength of the aluminum alloy.

3. The aluminum alloy of claim 2, wherein the alloy composition comprises nickel (Ni) in an amount of about 0.05 to 0.15 wt % of nickel (Ni) based on the total weight of the alloy composition.

4. A subframe, comprising an alloy composition, the alloy composition comprising an amount of about 0.15 to 0.25 wt % of iron (Fe), an amount of about 0.2 to 0.25 wt % of manganese (Mn), an amount of about 0.15 to 0.25 wt % of magnesium (Mg), an amount of about 7.5 to 9.0 wt % of silicon, and an amount of about 0.5 wt % or less of inevitable impurities, and a balance of aluminum (Al), all the wt % are based on the total weight of the alloy composition, and
wherein the content of manganese (Mn) is equal to or greater than the content of iron (Fe).

5. The subframe of claim 4, wherein the alloy composition further comprises an amount of about 0.05 to 0.15 wt % of nickel (Ni) based on the total weight of the alloy composition.

6. The subframe of claim 5, wherein the alloy composition prevents acicular phase of iron-based compound.

7. A vehicle comprising an aluminum alloy of claim 1.

8. A vehicle comprising a subframe of claim 4.
